(19) United States
(12) Patent Application Publication
(10) Pub. No.: US 2025/0055038 A1
(43) Pub. Date: Feb. 13, 2025

(54) MANUFACTURING METHOD OF ALL-SOLID-STATE RECHARGEABLE BATTERY AND RESULTING ALL-SOLID-STATE RECHARGEABLE BATTERY

(71) Applicant: SAMSUNG SDI CO., LTD., Yongin-si (KR)

(72) Inventors: Jinah LEE, Yongin-si (KR); Jinhee MOON, Yongin-si (KR); Yong Chul SEO, Yongin-si (KR); Riyul KIM, Yongin-si (KR); Jihyoung PARK, Yongin-si (KR); Jeonga MINN, Yongin-si (KR)

(21) Appl. No.: 18/798,986

(22) Filed: Aug. 9, 2024

(30) Foreign Application Priority Data
Aug. 11, 2023 (KR) 10-2023-0105732

(51) Int. Cl. H01M 10/0585; H01M 10/0562; H01M 50/431

(52) U.S. Cl. CPC H01M 10/0585; H01M 10/0562; H01M 50/431; H01M 2300/0071; H01M 2300/008

(57) ABSTRACT

An all-solid-state rechargeable battery manufacturing method includes forming a first laminate by stacking a first solid electrolyte layer on a first negative electrode, stacking a positive electrode on a first solid electrolyte layer of the first laminate, stacking a gasket at a distance from the positive electrode on the first solid electrolyte layer and forming a finishing portion in a gap between the positive electrode and the gasket.

### CROSS-REFERENCE TO RELATED APPLICATION

This application claims priority to and the benefit of Korean Patent Application No. 10-2023-0105732 filed in the Korean Intellectual Property Office on Aug. 11, 2023, the entire contents of which are incorporated herein by reference.

### BACKGROUND

### 1. Field

Embodiments relate to an all-solid-state secondary battery manufacturing method.

### 2. Description of the Related Art

Recently, the development of batteries with high energy density and safety is being actively conducted due to industry demands. For example, lithium-ion batteries are being put to practical use not only in the fields of information-related devices and communication devices, but also in the automobile field. In the automotive field, safety is particularly important because it is related to life.

Current commercially available lithium-ion batteries use an electrolyte solution containing flammable organic solvent, so there is a possibility of overheating and fire if a short circuit occurs.

The above-described information disclosed in the technology is only intended to improve understanding of the background of the present disclosure.

### SUMMARY

Embodiments include an all-solid-state rechargeable battery manufacturing method, including forming a first laminate by stacking a first solid electrolyte layer on a first negative electrode, stacking a positive electrode on a first solid electrolyte layer of the first laminate, stacking a gasket at a distance from the positive electrode on the first solid electrolyte layer and forming a finishing portion in a gap between the positive electrode and the gasket.

Forming the finishing portion may include using a positive active material of the positive electrode.

Forming the finishing portion may include using a solid electrolyte of the first solid electrolyte layer.

Forming the finishing portion may include using one of a powder application, a slurry spray coating and a slurry application.

Forming the finishing portion may further include filling the gap with the finishing portion by pressing the positive electrode, the gasket, and the finishing portion.

The all-solid-state rechargeable battery manufacturing method may further include forming a second laminate by stacking a second solid electrolyte layer on a second negative electrode and stacking the second solid electrolyte layer of the second laminate on the positive electrode, the finishing portion and the gasket.

The all-solid-state rechargeable battery manufacturing method may further include pressing the second laminate to fill the gap with the finishing portion by pressing the positive electrode, the gasket, and the finishing portion.

Embodiments include an all-sold-state rechargeable secondary battery, including a negative electrode, a solid electrolyte layer stacked on the negative electrode, and a positive electrode layer, including a positive electrode, a gasket and a finishing portion between the positive electrode and the gasket, wherein no gap is present in the positive electrode layer.

The negative electrode and the solid electrolyte layer may include a first laminate, the all-solid-state rechargeable secondary battery further including a second laminate stacked on the positive electrode layer.

The second laminate may include a second solid electrolyte layer stacked on the positive electrode layer and a second negative electrode stacked on the second solid electrolyte layer.

The negative electrode may include a precipitation-type negative electrode.

The negative electrode may include a current collector and a negative electrode coating layer on the current collector.

The negative electrode may further include a thin film between the current collector and a negative electrode coating layer.

The thin film may include a lithium alloy.

The positive electrode may include a current collector, a positive electrode active material and a conductive material.

The conductive material may include a carbon-based material and an oxide-based inorganic solid electrolyte.

The solid electrolyte layer may include a sulfide-based solid electrolyte.

The sulfide-based solid electrolyte may include argyrodite-type sulfide particles.

### BRIEF DESCRIPTION OF THE DRAWINGS

Features will become apparent to those of ordinary skill in the art by describing in detail exemplary embodiments with reference to the attached drawings, in which:

FIG. 1 is a cross-sectional view of an all-solid-state battery according to one or more embodiments of the present disclosure;

FIG. 2 is a cross-sectional view of an all-solid-state battery including a precipitation-type negative electrode according to one or more embodiments of the present disclosure;

FIG. 3 is a longitudinal cross-sectional view that shows forming a positive electrode in a first laminate formed by laminating a first solid electrolyte layer on a negative electrode in a manufacturing method of an all-solid-state rechargeable battery according to one or more embodiments of the present disclosure;

FIG. 4 is a longitudinal cross-sectional view of forming a gasket in the first laminate of FIG. 3;

FIG. 5 is a longitudinal cross-sectional view of forming an finishing portion between the positive electrode and the gasket of the first laminate of FIG. 4;

FIG. 6 is a top plan view of the all-solid-state rechargeable battery according to one or more embodiments of the present disclosure; and

FIG. 7 is a longitudinal cross-sectional view of forming a bi-cell by stacking a second laminate on a mono-cell of FIG. 5 in a manufacturing method of an all-solid-state rechargeable battery according to one or more embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those of ordinary skill in the art.

In the drawing figures, the dimensions of layers and regions may be exaggerated for clarity of illustration. It will also be understood that if a layer or element is referred to as being “on” another layer or substrate, it may be directly on the other layer or substrate, or intervening layers may also be present. Further, it will be understood that if a layer is referred to as being “under” another layer, it may be directly under, and one or more intervening layers may also be present. In addition, it will also be understood that if a layer is referred to as being “between” two layers, it may be the only layer between the two layers, or one or more intervening layers may also be present. Like reference numerals refer to like elements throughout.

In the following detailed description, only certain embodiments of the present disclosure have been shown and described, simply by way of illustration. As those of ordinary skill in the art would realize, the described embodiments may be modified in various different ways, all without departing from the spirit or scope of the present disclosure.

In addition, unless explicitly described to the contrary, the word “comprise”, and variations such as “comprises” or “comprising”, will be understood to imply the inclusion of stated elements but not the exclusion of any other elements.

It will be understood that if an element such as a layer, film, region, or substrate is referred to as being “on” another element, it may be directly on the other element or intervening elements may also be present. In contrast, if an element is referred to as being “directly on” another element, there are no intervening elements present.

In addition, “layer” herein includes not only a shape formed on the whole surface if viewed from a plan view, but also a shape formed on a partial surface. In this case, “or” is not to be construed as an exclusive meaning, and for example, “A or B” is construed to include A, B, A+B, and the like.

### Positive Electrode for All-Solid-State Secondary Battery

In an embodiment, there is provided a positive electrode for an all-solid-state rechargeable battery including a current collector and a positive electrode active material layer disposed on the current collector, wherein the positive electrode active material layer includes a positive electrode active material, a sulfide-based solid electrolyte, a binder, and a conductive material. However, this is not restrictive, and the positive electrode for the all-solid-state rechargeable battery may include more or less components than the components described above.

In an embodiment, the positive electrode for the all-solid-state rechargeable battery may be manufactured by applying a positive electrode composition including at least one of a positive active material, a sulfide-based solid electrolyte, a binder, and a conductive material to a current collector and then performing drying and rolling.

### Positive Active Material

The positive electrode active material may be varied, as long as it is commonly used for all-solid-state secondary batteries. For example, the positive electrode active material may be a compound capable of reversible intercalation and deintercalation of lithium and may include a compound represented by any of the following chemical formulas.

LiₐA_{1-b}X_{b}D₂(0.90≤a≤1.8,0≤b≤0.5);

LiₐA_{1-b}X_{b}O_{2-c}D_{c}(0.90≤a≤1.8,0≤b≤0.5,0≤c≤0.05);

LiₐE_{1-b}X_{b}O_{2-c}D_{c}(0.90≤a≤1.8,0≤b≤0.5,0≤c≤0.05);

LiₐE_{2-b}X_{b}O_{4-c}D_{c}(0.90≤a≤1.8,0≤b≤0.5,0≤c≤0.05);

LiₐNi_{1-b-e}Co_{b}X_{c}Dₐ(0.90≤a≤1.8,0≤b≤0.5,0≤c≤0.5,0<α≤2);

LiₐNi_{1-b-c}CO_{b}X_{c}O₂₋ₐTₐ(0.90≤a≤1.8,0≤b≤0.5,0≤c≤0.05,0<α≤2);

LiₐNi_{1-b-c}CO_{b}X_{c}O₂₋ₐT₂(0.90≤a≤1.8,0≤b≤0.5,0≤c≤0.05,0<α≤2);

LiₐNi_{1-b-c}Mn_{b}X_{c}Dₐ(0.90≤a≤1.8,0≤b≤0.5,0≤c≤0.05,0<α≤2);

LiₐNi_{1-b-c}Mn_{b}X_{c}O₂₋ₐTₐ(0.90≤a≤1.8,0≤b≤0.5,0≤c≤0.05,0<α≤2);

LiₐNi_{1-b-c}Mn_{b}X_{c}O₂₋ₐT₂(0.90≤a≤1.8,0≤b≤0.5,0≤c≤0.05,0<α≤2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂(0.90≤a≤1.8,0≤b≤0.9,0≤c≤0.5,0≤d≤0.5,0.001≤e≤0.1);

LiₐNiG_{b}O₂(0.90≤a≤1.8,0.001≤b≤0.1);

LiₐCoG_{b}O₂(0.90≤a≤1.8,0.001≤b≤0.1);

LiₐMn_{1-g}G_{b}O₂(0.90≤a≤1.8,0.001≤b≤0.1);

LiₐMn₂G_{b}O₄(0.90≤a≤1.8,0.001≤b≤0.1);

LiₐMn_{1-g}G_{g}PO₄(0.90≤a≤1.8,0≤g≤0.5);

QO₂;QS₂;LiQS₂;

V₂O₅;LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2); or

LiₐFePO₄(0.90≤a≤1.8).

In the above Chemical Formulas, A may include Ni, Co, Mn, or a combination thereof; X may include Al, Ni, Co, Mn, Cr, Fe, Mg, Sr, V, rare earth elements, or a combination thereof; D may include O, F, S, P, or a combination thereof; E may include Co, Mn, or a combination thereof; T may include F, S, P, or a combination thereof; G may include Al, Cr, Mn, Fe, Mg, La, Ce, Sr, V, or a combination thereof; Q may include Ti, Mo, Mn, or a combination thereof; Z may include Cr, V, Fe, Sc, Y, or a combination thereof; and J may include V, Cr, Mn, Co, Ni, Cu, or a combination thereof.

The positive electrode active material may include, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), and lithium nickel manganese oxide (NM), lithium manganese oxide (LMO), or lithium ferrous phosphate oxide (LFP).

The positive electrode active material may include a lithium nickel-based oxide represented by Chemical Formula 1 below, a lithium cobalt-based oxide represented by Chemical Formula 2 below, a lithium ferrous phosphate-based compound represented by Chemical Formula 3 below, or a combination thereof.

Liₐ₁Niₓ₁M¹_{y1}M²_{1-x1-y1}O₂ [Chemical Formula 1]

In Chemical Formula 1, 0.9≤a1≤1.8, 0.3≤x1≤1, 0≤y1<0.7, and M¹ and M² may each be one or more elements independently selected from Al, B, Ba, Ca, Ce, Co, Cr, Cu, F, Fe, Mg, Mn, Mo, Nb, P, S, Si, Sr, Ti, V, W, and Zr.

Liₐ₂Coₓ₂M³₁₋ₓ₂O₂ [Chemical Formula 2]

In Chemical Formula 2, 0.9≤a2≤1.8, 0.6≤x2≤1, and M³ may be one or more elements selected from Al, B, Ba, Ca, Ce, Cr, Cu, F, Fe, Mg, Mn, Mo, Nb, P, S, Si, Sr, Ti, V, W, and Zr.

Liₐ₃Feₓ₃M⁴₁₋ₓ₃PO₄ [Chemical Formula 3]

In Chemical Formula 3, 0.9≤a3≤1.8, 0.6≤x3≤1, and M⁴ may be one or more elements selected from Al, B, Ba, Ca, Ce, Co, Cr, Cu, F, Fe, Mg, Mn, Mo, Nb, P, S, Si, Sr, Ti, V, W, and Zr.

An average particle diameter (D₅₀) of the positive electrode active material may be 1 μm to 25 μm, for example, 3 μm to 25 μm, 5 μm to 25 μm, 5 μm to 20 μm, 8 μm to 20 μm, or 10 μm to 18 μm. The positive electrode active material having the particle diameter range may be harmoniously mixed with other components in the first positive electrode active material layer and may implement the high capacity and high energy density.

The positive electrode active material may include a secondary particle made by agglomeration of a plurality of primary particles, or may include a single particle. In addition, the positive electrode active material may be spherical or close to a spherical shape, or may be polyhedral or amorphous.

### Sulfide-Based Solid Electrolyte

The sulfide-based solid electrolyte may include, for example, Li₂S—P₂S₅, Li₂S—P₂S₅—LiX (X may be a halogen element, for example I, or CI), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer, and Z may be Ge, Zn, or Ga), Li₂S—GeS₂, Li₂S—SiS₂—Li₃PO₄, Li₂S—SiS₂-LiₚMO_{q} (p and q are integers, and M may be P, Si, Ge, B, Al, Ga, or In), or a combination thereof.

The sulfide-based solid electrolyte may be obtained by, for example, mixing Li₂S and P₂S₅ at a molar ratio of 50:50 to 90:10 or 50:50 to 80:20 and optionally heat treating the mixture. Within the above mixing ratio range, a sulfide-based solid electrolyte having excellent ionic conductivity may be manufactured. In this case, SiS₂, GeS₂, B₂S₃ and the like as other components may be further included to further improve the ionic conductivity.

A mechanical milling or solution method may include a method of mixing sulfur-containing raw materials for producing a sulfide-based solid electrolyte. Mechanical milling is a method of making starting materials into particulates and mixing the same by putting the starting materials, ball mills, and the like in a reactor and intensely stirring them. In the solution method, starting materials may be mixed in a solvent to obtain a solid electrolyte as a precipitate. Furthermore, if heat treatment is performed after mixing, crystals of the solid electrolyte may become more rigid and ionic conductivity may be improved. As an example, the sulfide-based solid electrolyte may be manufactured by mixing sulfur-containing raw materials and heat-treating them two or more times. In this case, a sulfide-based solid electrolyte with high ionic conductivity and rigidity may be manufactured.

As an example, the sulfide-based solid electrolyte particles may include argyrodite-type sulfide. The argyrodite-type sulfide may be represented by, for example, a Chemical Formula of LiₐM_{b}P_{c}S_{d}Aₑ (a, b, c, d, and e may each be 0 or greater and 12 or less, M may be a metal excluding Li or a combination of metals excluding Li, and A may be F, Cl, Br, or I), and for example, may be represented by a Chemical Formula of Li₇₋ₓPS₆₋ₓAₓ (where x is 0.2 or greater and 1.8 or less, and A may be F, Cl, Br, or I). The argyrodite-type sulfide may be, for example, Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8} or the like.

A sulfide-based solid electrolyte particle containing such argyrodite-type sulfide has high ionic conductivity close to about 10-4 to about 10-2 S/cm, which is ionic conductivity of a general liquid electrolyte, at room temperature, and thus, may form a close bond between the positive electrode active material and the solid electrolyte and further, a close interface between the electrode layer and the solid electrolyte layer without deteriorating the ionic conductivity. An all-solid-state battery including the same may exhibit improved battery performance such as rate characteristics, coulombic efficiency, and life characteristics.

The argyrodite-type sulfide-based solid electrolyte may be manufactured by, for example, mixing lithium sulfide, phosphorus sulfide, and optionally lithium halide. After mixing them, heat treatment may be performed. The heat treatment may include, for example, two or more heat treatment steps.

In some embodiments, an average particle diameter (D₅₀) of the sulfide-based solid electrolyte particle according to an embodiment may be 5.0 μm or less, for example, 0.1 μm to 5.0 μm, 0.1 μm to 4.0 μm, 0.1 μm to 3.0 μm, 0.5 μm to 2.0 μm, or 0.1 μm to 1.5 μm. In other embodiments, the sulfide-based solid electrolyte particle may be a small particle having an average particle diameter (D₅₀) of 0.1 μm to 1.0 μm or a large particle having an average particle diameter (D₅₀) of 1.5 μm to 5.0 μm, depending on the location or application. The sulfide-based solid electrolyte particle in the particle diameter range above may effectively penetrate between solid particles in the battery, and has an excellent contact property with the electrode active material and connectivity between the solid electrolyte particles. The average particle diameter of the sulfide-based solid electrolyte particle may be measured using a microscope image. For example, a particle size distribution may be obtained by measuring sizes of about 20 particles in a scanning electron microscope image, and D₅₀ may be calculated from the particle size distribution.

The content of the solid electrolyte in the positive electrode for an all-solid-state rechargeable secondary battery may be 0.5 wt % to 35 wt %, for example, 1 wt % to 35 wt %, 5 wt % to 30 wt %, 8 wt % to 25 wt %, or 10 wt % to 20 wt %, where “wt %” may be a content with respect to a total weight of components in the positive electrode, and for example, may be a content with respect to a total weight of the positive electrode active material layer.

In an embodiment, the first positive electrode active material layer may include 50 wt % to 99.35 wt % of the positive electrode active material, 0.5 wt % to 35 wt % of the sulfide-based solid electrolyte, 0.1 wt % to 10 wt % of the fluorine-based resin binder, and 0.05 wt % to 5 wt % of the vanadium oxide with respect to 100 wt % of the first positive electrode active material layer. If such content ranges are satisfied, the positive electrode for an all-solid-state rechargeable battery may maintain high adhesive force and also may maintain the viscosity of the positive electrode composition at an appropriate level while implementing high capacity and high ionic conductivity, thereby improving processability.

### Binder

The binder serves to adhere the positive active material particles to each other and to the current collector. Representative examples of the binder include polyvinylalcohol, carboxylmethylcellulose, hydroxypropylcellulose, diacetylcellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, nylon, and the like may be used, but is not limited thereto.

The first positive electrode active material layer may further include a conductive material. The conductive material may be used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber containing copper, nickel, aluminum, silver, and the like; a conductive polymer such as a polyphenylene derivative; or a combination thereof.

### Conductive Material

The conductive material may be included in an amount of 0.1 wt % to 5 wt %, or 0.1 wt % to 3 wt % with respect to a total weight of each component of the positive electrode for an all-solid-state battery, or with respect to the total weight of the first positive electrode active material layer. Within the above content range, the conductive material may improve electrical conductivity without deteriorating battery performance.

If the first positive electrode active material layer further includes a conductive material, the first positive electrode active material layer may include 45 wt % to 99.25 wt % of the positive electrode active material, 0.5 wt % to 35 wt % of the sulfide-based solid electrolyte, 0.1 wt % to 10 wt % of the fluorine-based resin binder, 0.05 wt % to 5 wt % of the vanadium oxide, and 0.1 wt % to 5 wt % of the conductive material with respect to 100 wt % of the first positive electrode active material layer.

Note that the positive electrode for a lithium rechargeable battery may further include an oxide-based inorganic solid electrolyte, in addition to the solid electrolyte described above. The oxide-based inorganic solid electrolyte may include, for example, Li₁₊ₓTi₂₋ₓAl (PO₄)₃(LTAP) (0≤x≤4), Li_{1+x+y}AlₓTi₂₋ₓSi_{y}P_{3-y}O₁₂ (0<x<2,0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB (Mg₃Nb_{2/3}) O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al,Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, garnet-based ceramics Li₃₊ₓLa₃M₂O₁₂ (M=Te, Nb, or Zr; x may be an integer from 1 to 10), or a combination thereof.

### All-Solid-State Secondary Battery

One or more embodiments provide an all-solid-state rechargeable battery including the positive electrode described above, a negative electrode, and a solid electrolyte layer positioned between the positive electrode and the negative electrode. The all-solid-state rechargeable battery may be expressed as an all-solid-state battery or an all-solid-state lithium rechargeable battery.

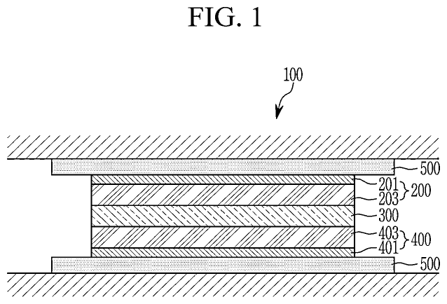

FIG. 1 is a cross-sectional view of an all-solid-state battery according to one or more embodiments. Referring to FIG. 1, an all-solid-state battery 100 may include an electrode assembly in which a negative electrode 400 including a negative electrode current collector 401 and a negative electrode active material layer 403, a solid electrolyte layer 300, and a positive electrode 200 including a positive electrode active material layer 203 and a positive electrode current collector 201 may be stacked and may be stored in a case such as a pouch. The all-solid-state battery 100 may further include an elastic layer 500 on an outer side of at least one of the positive electrode 200 and the negative electrode 400. Although FIG. 1 shows one electrode assembly including the negative electrode 400, the solid electrolyte layer 300, and the positive electrode 200, an all-solid-state battery may be manufactured by stacking two or more electrode assemblies.

### Negative Electrode

The negative electrode for an all-solid-state battery may include, for example, a current collector and a negative electrode active material layer positioned on the current collector. The negative electrode active material layer may include a negative electrode active material and may further include a binder, a conductive material, and/or a solid electrolyte.

The negative electrode active material may include a material capable of reversibly intercalation/deintercalating lithium ions, lithium metal, an alloy of lithium metal, a material capable of being doped and undoped on lithium, or a transition metal oxide.

The material capable of reversibly intercalating/deintercalating lithium ions may be a carbon-based negative electrode active material, and may include, for example, crystalline carbon, amorphous carbon, or a combination thereof. Examples of the crystalline carbon may include graphite such as amorphous, plate-like, flake-like, spherical or fibrous natural graphite or artificial graphite, and examples of the amorphous carbon may include soft carbon or hard carbon, mesophase pitch carbide, fired coke, and the like.

For the alloy of the lithium metal, an alloy of lithium and one or more metals selected from Na, K, Rb, Cs, Fr, Be, Mg, Ca, Sr, Si, Sb, Pb, In, Zn, Ba, Ra, Ge, Al and Sₙ may be used.

For the material capable of being doped or undoped on the lithium, a Si-based negative electrode active material or an Sₙ-based negative electrode active material may be used. Examples of the Si-based negative electrode active material may include silicon, silicon-carbon composite, SiOₓ (0<x≤2), and a Si-Q alloy (Q may be an element selected from alkali metals, alkali earth metals, Group 13 elements, Group 14 elements, Group 15 elements, Group 16 elements, transition metals, rare-earth elements, and combinations thereof, but is not Si). Examples of the Sₙ-based negative electrode active material may include Sₙ, SnO₂, a Sₙ—R alloy (R may be an element selected from alkali metals, alkali earth metals, Group 13 elements, Group 14 elements, Group 15 elements, Group 16 elements, transition metals, rare-earth elements, and combinations thereof, but is not Sₙ). In addition, a mixture of at least one thereof and SiO₂ may be used. The elements Q and R may be Mg, Ca, Sr, Ba, Ra, Sc, Y, Ti, Zr, Hf, Rf, V, Nb, Tₐ, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sₙ, In, Tl, Ge, P, As, Sb, Bi, S, Se, Te, Po, or a combination thereof.

The silicon-carbon composite may be, for example, a silicon-carbon composite including a core including crystalline carbon and a silicon particle and an amorphous carbon coating layer positioned on a surface of the core. The crystalline carbon may be artificial graphite, natural graphite, or a combination thereof. As the amorphous carbon precursor, coal-based pitch, mesophase pitch, petroleum-based pitch, coal-based oil, petroleum-based heavy oil, or polymer resin such as phenol resin, furan resin, and polyimide resin may be used. In this case, a content of silicon may be 10 wt % to 50 wt % with respect to a total weight of the silicon-carbon composite. In addition, a content of the crystalline carbon may be 10 wt % to 70 wt % with respect to the total weight of the silicon-carbon composite, and a content of the amorphous carbon may be 20 wt % to 40 wt % with respect to the total weight of the silicon-carbon composite. In addition, a thickness of the amorphous carbon coating layer may be 5 nm to 100 nm.

An average particle diameter (D₅₀) of the silicon particle may be 10 nm to 20 μm, and for example, 10 nm to 500 nm. The silicon particle may be present in an oxidized form, and in this case, an atomic content ratio of Si: O in the silicon particle, which indicates a degree of oxidation, may be 99:1 to 33:67. The silicon particle may be a SiOₓ particle, in which case a range of x in SiOₓ may be greater than 0 and less than 2. For example, the average particle diameter (D₅₀) may be measured with a particle size analyzer using a laser diffraction method and refers to a diameter of a particle with a cumulative volume of 50% by volume in the particle size distribution.

The Si-based negative electrode active material or Sₙ-based negative electrode active material may be used by mixing with a carbon-based negative electrode active material. A mixing ratio of the Si-based negative electrode active material or Sₙ-based negative electrode active material and the carbon-based negative electrode active material may be 1:99 to 90:10 at a weight ratio.

The content of the negative electrode active material in the negative electrode active material layer may be 95 wt % to 99 wt % with respect to the total weight of the negative electrode active material layer.

In an embodiment, the negative electrode active material layer may further include a binder, and optionally, may further include a conductive material. A content of the binder in the negative electrode active material layer may be 1 wt % to 5 wt % with respect to the total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to adhere the negative electrode active material particles to each other well and also to adhere the negative electrode active material to the current collector well. The binder may include a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, and a combination thereof.

Examples of the water-soluble binder may include a rubber-based binder or a polymer resin binder. The rubber-based binder may be a styrene-butadiene rubber, an acrylated styrene-butadiene rubber, an acrylonitrile-butadiene rubber, an acrylic rubber, a butyl rubber, a fluoro rubber, or a combination thereof. The polymer resin binder may be polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, or a combination thereof.

If a water-soluble binder is used as the negative electrode binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight with respect to 100 parts by weight of the negative electrode active material.

The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of a metal powder or a metal fiber including copper, nickel, aluminum, silver, and the like; a conductive polymer such as a polyphenylene derivative; or a mixture thereof.

The negative electrode current collector may include a copper foil, a nickel foil, a stainless steel foil, a titanium foil, a nickel foam, a copper foam, a polymer substrate coated with a conductive metal, or a combination thereof.

As another example, the negative electrode for an all-solid-state battery may be a precipitation-type negative electrode. The precipitation-type negative electrode refers to a negative electrode which does not include a negative electrode active material during assembling of a battery but in which lithium metal or the like is precipitated during charging of the battery and serves as a negative electrode active material.

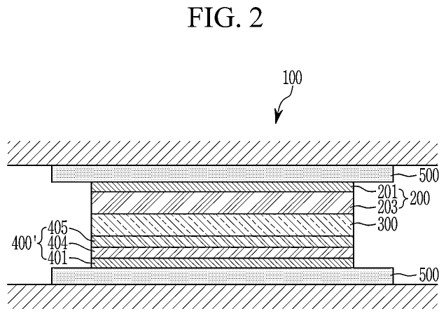

FIG. 2 is a cross-sectional view of an all-solid-state battery including a precipitation-type negative electrode according to one or more embodiments. Referring to FIG. 2, the precipitation-type negative electrode 400′ may include a current collector 401 and a negative electrode coating layer 405 positioned on the current collector. In an all-solid-state battery having the precipitation-type negative electrode 400′, initial charging may begin in the absence of a negative electrode active material, and during the charging, lithium metal with a high density or the like may be precipitated between the current collector 401 and the negative electrode coating layer 405 and forms a lithium metal layer 404, which may serve as a negative electrode active material. Accordingly, in an all-solid-state battery that has been charged once or more, the precipitation-type negative electrode 400′ may include the current collector 401, the lithium metal layer 404 positioned on the current collector, and the negative electrode coating layer 405 positioned on the lithium metal layer 404. The lithium metal layer 404 refers to a layer of lithium metal or the like precipitated during the charging process of the battery and may be called a metal layer or a negative electrode active material layer.

The negative electrode coating layer 405 may include metal, a carbon material, or a combination thereof that serves as a catalyst.

The metal may include, for example, gold, platinum, palladium, silicon, silver, aluminum, bismuth, tin, zinc, or a combination thereof, and may include one selected therefrom or an alloy of more than one thereof. If the metal is present in the form of a particle, an average particle diameter (D₅₀) thereof may be about 4 μm or less, for example, 10 nm to 4 μm.

The carbon material may be, for example, crystalline carbon, amorphous carbon, or a combination thereof. The crystalline carbon may be, for example, natural graphite, artificial graphite, a mesophase carbon microbead, or a combination thereof. The amorphous carbon may be, for example, carbon black, activated carbon, acetylene black, Denka black, Ketjen black, or a combination thereof.

If the negative electrode coating layer 45 includes both the metal and the carbon material, a mixing ratio of the metal and the carbon material may be, for example, 1:10 to 2:1 at a weight ratio. In this case, the precipitation of lithium metal may be effectively promoted and the characteristics of the all-solid-state battery may be improved. The negative electrode coating layer 45 may include, for example, a carbon material on which catalyst metal is supported, or a mixture of metal particles and carbon material particles.

The negative electrode coating layer 405 may include, for example, the metal and amorphous carbon, and in this case, the precipitation of lithium metal may be effectively promoted.

The negative electrode coating layer 405 may further include a binder, and the binder may be a conductive binder. The negative electrode coating layer 405 may further include general additives such as a filler, a dispersant, and an ion conductive material.

A thickness of the negative electrode coating layer 405 may be, for example, 100 nm to 20 μm, 500 nm to 10 μm, or 1 μm to 5 μm.

For example, the precipitation-type negative electrode 400′ may further include a thin film on the surface of the current collector, that is, between the current collector and the negative electrode coating layer. The thin film may contain an element that may form an alloy with lithium. The element that may form an alloy with lithium may be, for example, gold, silver, zinc, tin, indium, silicon, aluminum, bismuth, and the like, which may be used alone or as an alloy of more than one thereof. The thin film may further planarize a precipitation shape of the lithium metal layer 404 and further improve the characteristics of the all-solid-state battery. The thin film may be formed by, for example, a vacuum deposition method, a sputtering method, a plating method, or the like. The thin film may have a thickness ranging from 1 nm to 500 nm, for example.

### Solid Electrolyte Layer

The solid electrolyte layer 300 may include a sulfide-based solid electrolyte, an oxide-based solid electrolyte, or the like. The specific description of the sulfide-based solid electrolyte and the oxide-based solid electrolyte are the same as above.

In one example, the solid electrolyte included in the positive electrode 200 and the solid electrolyte included in the solid electrolyte layer 300 may include the same compound or different compounds. For example, if both the positive electrode 200 and the solid electrolyte layer 300 include an argyrodite-type sulfide-based solid electrolyte, the overall performance of the all-solid-state rechargeable battery may be improved. Furthermore, as an example, if both the positive electrode 200 and the solid electrolyte layer 300 include the coated solid electrolyte described above, the all-solid-state rechargeable battery may implement excellent initial efficiency and life characteristics while implementing a high capacity and a high energy density.

Note that the average particle diameter (D₅₀) of the solid electrolyte included in the positive electrode 200 may be smaller than the average particle diameter (D₅₀) of the solid electrolyte included in the solid electrolyte layer 300. In this case, the overall performance may be improved by maximizing the energy density of the all-solid-state battery and increasing the mobility of lithium ions. For example, the average particle diameter (D₅₀) of the solid electrolyte included in the positive electrode 200 may be 0.1 μm to 1.0 μm, or 0.1 μm to 0.8 μm, and the average particle diameter (D₅₀) of the solid electrolyte included in the solid electrolyte layer 300 may be 1.5 μm to 5.0 μm, 2.0 μm to 4.0 μm, or 2.5 μm to 3.5 μm. If the above particle diameter ranges are satisfied, the energy density of the all-solid-state rechargeable battery may be maximized and the transfer of lithium ions facilitated, making it possible to suppress resistance and thus to improve the overall performance of the all-solid-state rechargeable battery. In this case, the average particle diameter (D₅₀) of the solid electrolyte may be measured, for example, with a particle size analyzer using a laser diffraction method. Alternatively, a particle size distribution may be obtained by measuring sizes of about 20 particles selected from a microscope image such as a scanning electron microscope, and a D₅₀ value may be calculated from the particle size distribution.

The solid electrolyte layer may further include a binder, in addition to the solid electrolyte. In this case, for the binder, a styrene butadiene rubber, polytetrafluoroethylene, polyvinylidene fluoride, polyethylene, an acrylate-based polymer, or a combination thereof may be used, but the present disclosure is not limited thereto, and any binder used in the art may be used. The acrylate-based polymer may be, for example, butyl acrylate, polyacrylate, polymethacrylate, or a combination thereof.

The solid electrolyte layer may be formed by adding a solid electrolyte to a binder solution, coating a base film with the solution, and drying the resultant. The solvent for the binder solution may be isobutyryl isobutyrate, xylene, toluene, benzene, hexane, or a combination thereof. A process of forming the solid electrolyte layer is widely known in the art, and therefore, a detailed description will be omitted.

A thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. A content of the lithium salt in the solid electrolyte layer may be 1 M or more, for example, 1 M to 4 M. In this case, the lithium salt may improve ionic conductivity by improving lithium ion mobility in the solid electrolyte layer.

The lithium salt may include, for example, LiSCN, LIN(CN)₂, Li(CF₃SO₂)₃C, LiC₄F₉SO₃, LIN(SO₂CF₂CF₃)₂, LiCl, LiF, LiBr, LiI, LiB C₂O₄₂, LiBF₄, LiBF₃ C₂F₅, lithium bis(oxalato) borate (LiBOB), lithium oxalyldifluoroborate (LIODFB), lithium difluoro (oxalato) borate (LiDFOB), lithium bis(trifluoro methanesulfonyl)imide, LiTFSI, LiN(SO₂CF₃)₂), lithium bis(fluorosulfonyl)imide (LiFSI, LIN(SO₂F)₂), LiCF₃SO₃, LiAsF₆, LiSbF₆, LiClO₄, or a mixture thereof.

Furthermore, the lithium salt may be an imide-based salt. For example, the imide-based lithium salt may include lithium bis(trifluoro methanesulfonyl)imide, LiTFSI, LIN (SO₂CF₃) 2), lithium bis(fluorosulfonyl)imide, LiFSI, LiN(SO₂F)₂). The lithium salt may maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature and is composed of only ions.

The ionic liquid may be a compound including a) one or more cations selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, and triazolium-based cations or a mixture thereof, and b) one or more anions selected from BF₄⁻, PF₆⁻, AsF₆⁻, SbF₆⁻, AlCl₄⁻, HSO₄⁻, CIO₄⁻, CH₃SO₃⁻, CF₃CO₂⁻, Cl⁻, Br⁻, I⁻, BF₄⁻, SO₄⁻, CF₃SO₃⁻, FSO₂₂N⁻, (C₂FsSO₂)₂N⁻, (C₂FsSO₂, CF₃SO₂)N⁻, and (CF₃SO₂)₂N⁻.

The ionic liquid may be, for example, one or more of N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. The solid electrolyte layer that satisfies the above ranges may maintain or improve ionic conductivity by improving the electrochemical contact area with the electrode. Accordingly, the energy density, discharge capacity, rate characteristics, and the like of the all-solid-state battery may be improved.

The all-solid-state battery may include a unit cell having a structure of a positive electrode/a solid electrolyte layer/a negative electrode, a bi-cell structure having a structure of a negative electrode/a solid electrolyte layer/a positive electrode/a solid electrolyte layer/a negative electrode, or a bipolar cell structure in which unit cells are repeatedly stacked.

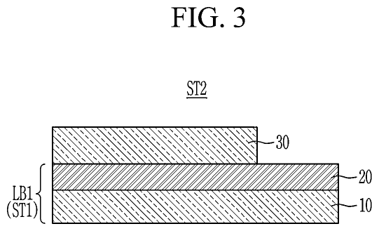

A shape of the all-solid-state battery may be varied, and may be, for example, a coin shape, a button shape, a sheet shape, a stack shape, a cylindrical shape, a flat shape, or the like. In addition, the all-solid-state battery may also be applied to large-sized batteries used in electric vehicles, and the like. For example, the all-solid-state battery may also be used in a hybrid vehicle such as a plug-in hybrid electric vehicle (PHEV). Furthermore, it may be used in fields that require a large amount of power storage, and for example, may also be used for an electric bicycle, an electric tool or the like. Hereinafter, referring to FIG. 3 to FIG. 5, a manufacturing method of an all-solid-state rechargeable battery according to a first embodiment will be described.

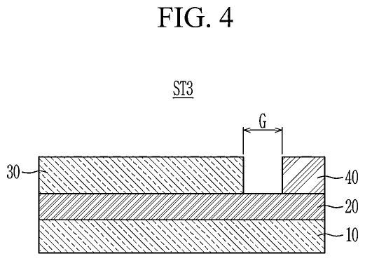

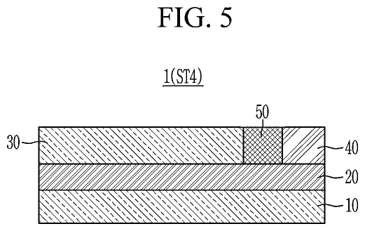

FIG. 3 is a longitudinal cross-sectional view that shows forming a positive electrode in a first laminate formed by laminating a first solid electrolyte layer on a negative electrode in a manufacturing method of an all-solid-state rechargeable battery according to one or more embodiments of the present disclosure, FIG. 4 is a longitudinal cross-sectional view of forming a gasket in the first laminate of FIG. 3, and FIG. 5 is a longitudinal cross-sectional view of forming a finishing portion between the positive electrode and the gasket of the first laminate of FIG. 4.

Referring to FIG. 3 to FIG. 5, the manufacturing method of the all-solid-state rechargeable battery according to one or more embodiments includes a first step ST1, a second step ST2 (FIG. 3), a third step ST3 (FIG. 4), and a fourth step ST4 (FIG. 5).

An all-solid-state rechargeable battery 1 manufactured using the manufacturing method of one or more embodiments includes a negative electrode 10, a solid electrolyte layer 20, a positive electrode 30, and a gasket 40 for providing insulation function while compensating for a thickness difference between the negative electrode 10 and the positive electrode 30. It may be necessary to reduce a gap G set between the gasket 40 and the positive electrode 30 in the stacking structure of the all-solid-state rechargeable battery 1.

Referring to FIG. 3, in the first step ST1, a first laminate LB1 is formed by stacking the solid electrolyte layer 20 on the negative electrode 10. Hereinafter, for convenience, the negative electrode 10 will be referred to as a first negative electrode 10, and the solid electrolyte layer 20 will be referred to as a first solid electrolyte layer 20. In the second step ST2, the positive electrode 30 is stacked on the first solid electrolyte layer 20 of the first laminate LB1.

In the third step ST3 (FIG. 4), the gasket 40 may be stacked on the first solid electrolyte layer 20, while being spaced apart from the positive electrode 30. Accordingly, the gap G is set between the positive electrode 30 and the gasket 40. The gap G between the positive electrode 30 and the gasket 40 is caused by errors due to equipment tolerances and manual work, and therefore it may become larger during a scale-up process of the all-solid-state rechargeable battery 1.

In the fourth step ST4, the finishing portion 50 is formed in the gap G. The finishing portion 50 compensates for a thickness difference between negative electrode 10 and positive electrode 30 due to the gasket 40. At the same time, the finishing portion fills the gap G between the gasket 40 and the positive electrode 30.

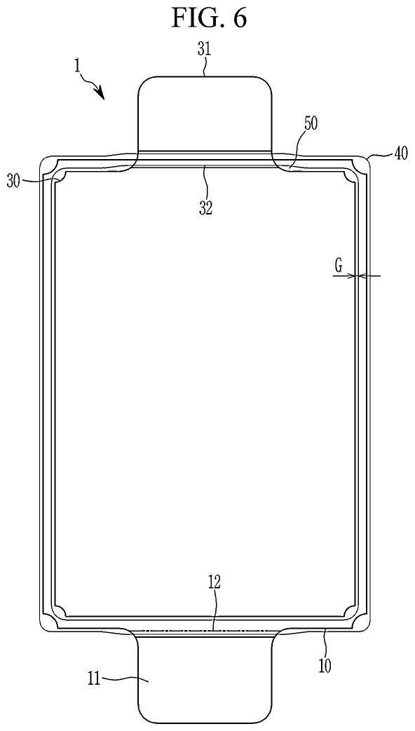

FIG. 6 is a top plan view of the all-solid-state rechargeable battery according to one or more embodiments of the present disclosure. Referring to FIG. 6, in the all-solid-state rechargeable battery 1 according to one or more embodiments, a positive electrode material tab 31 of the positive electrode 30 and a negative electrode material tab 11 of the negative electrode 10 may be drawn out from both ends.

The positive electrode 30 may be formed in an area smaller than an inner space of the gasket 40 and may be placed in the inner space of the gasket 40. Therefore, a connection portion 32 between the positive electrode 30 and the positive electrode material tab 31 may be placed in the inner space of the gasket 40, and the positive electrode material tab 31 may be drawn outward while being supported by the gasket 40 in the inner space.

The negative electrode 10 may be formed in an area larger than the inner space of the gasket 40, and thus an outer portion of the negative electrode 10 may be placed on the gasket 40. Therefore, a connection portion 12 of the negative electrode 10 and the negative electrode material tab 11 may be placed on the gasket 40, and the negative electrode material tab 11 may be drawn outward on the gasket 40.

In the fourth step ST4, the finishing portion 50 may be formed with a positive active material of the positive electrode 30, for example, a positive active material powder. In this case, since the positive active material powder has a relatively small particle size, the gap G may be filled more precisely. The positive active material powder may include a small amount of binder. The positive active material filled in the gap G may increase the capacity of the battery.

In the fourth ST4, the finishing portion 50 may be formed by powder application, slurry spray coating, or slurry application. As an example, the finishing portion 50 may be formed by applying positive active material powder to the gap G, spray coating positive active material slurry on the gap G, or applying positive active material slurry on the gap G.

In addition, in the fourth step ST4, the finishing portion 50 may be formed with solid electrolyte of the first solid electrolyte layer 20. In this case, since the solid electrolyte powder has a relatively small particle size, the gap G may be filled more precisely. The solid electrolyte, for example, a solid electrolyte powder, may contain a small amount of binder. As an example, finishing portion 50 may be formed by applying solid electrolyte powder to the gap G, spray coating solid electrolyte slurry on the gap G, or applying solid electrolyte slurry on the gap G.

The fourth step ST4 may further include filling the gap G with the finishing portion 50 by pressing the positive electrode 30, the gasket 40, and the finishing portion 50. As an example, a warm isostatic pressing (WIP) process may be carried out to fill the gap G the between positive electrode 30 and the gasket 40 with the positive active material powder or solid electrolyte powder to thereby form the finishing portion 50.

The gasket 40 and the finishing portion 50 enable the WIP process to proceed smoothly, and remove a difference in thickness between the positive electrode 30 and the gasket 40 on the first solid electrolyte 20, thereby preventing crack generation at the end of the positive electrode 30.

The gasket 40 and the finishing portion 50 allow isostatic pressure to be applied to the positive electrode material tab 31 and the negative electrode material tab 11 and connecting portions 32 and 12 disposed in the finishing portion 50 during the WIP process. Therefore, cracks and secondary reactions may be prevented in the positive electrode material tab 31, the negative electrode material tab 11 and connection portions 32 and 12 disposed in the gap G, thereby presenting initial short circuit of the cell.

Another embodiment of the present disclosure will now be described. Compared to the embodiment(s) described above, the description of the same configuration is omitted, and the additional configuration will be described.

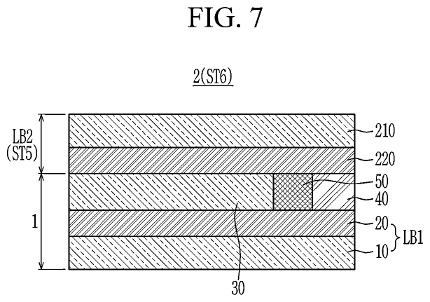

FIG. 7 is a longitudinal cross-sectional view of forming a bi-cell by stacking a second laminate on a mono-cell of FIG. 5 in a manufacturing method of an all-solid-state rechargeable battery according to another embodiment of the present disclosure. Referring to FIG. 7, a manufacturing method of an all-solid-state rechargeable battery according to a second embodiment of the present disclosure further includes a fifth step ST5 and a sixth step ST6.

In the fifth step ST5, a second negative electrode 210 is stacked on a second solid electrolyte layer 220 such that a second laminate LB2 is formed. The fifth step ST5 is the same as the first step ST1 in which the first laminate LB1 is formed by stacking the solid electrolyte layer 20 on the negative electrode 10.

In the sixth step ST6, the second solid electrolyte layer 220 of the second laminate LB2 is stacked on a positive electrode 30, a finishing portion 50, and a gasket 40. In the sixth step ST6, the positive electrode 30, the gasket 40, and the finishing portion 50 may be pressed to fill the gap (G) with the finishing portion 50 by pressing the second laminate LB2.

Since the gasket 40 and the finishing portion 50 remove a thickness difference of the positive electrode 30 and the gasket 40 between a first laminate LB1 and a second laminate LB2, thereby preventing crack generation at an end of the positive electrode 30.

The gasket 40 and the finishing portion 50 that are disposed between the first laminate LB1 and the second laminate LB2 enable a WIP process to be carried out smoothly. Therefore, cracks and negative reactions may be prevented on positive and negative electrodes material tabs 31 and 11 and connection portions 32 and 12 disposed corresponding to a gap G, and thus, a short circuit of the cell may be prevented.

Since the all-solid-state secondary battery disclosed herein does not use a flammable organic solvent, the possibility of fire or explosion may be greatly reduced even if a short circuit occurs. Therefore, these all-solid-state rechargeable batteries may greatly increase safety compared to lithium-ion batteries using electrolyte solutions.

What has been described above is only an embodiment for implementing an all-solid-state rechargeable battery according to the present disclosure. The present disclosure is not limited to the above-described embodiment, and as claimed in the following patent claims, it may fall within in the scope of the present disclosure to a range in which various changes may be made by anyone in the field to which the disclosure pertains without departing from the gist of the present disclosure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid-state rechargeable battery manufacturing method, comprising:
forming a first laminate by stacking a first solid electrolyte layer on a first negative electrode;
stacking a positive electrode on the first solid electrolyte layer of the first laminate;
stacking a gasket at a distance from the positive electrode on the first solid electrolyte layer; and
forming a finishing portion in a gap between the positive electrode and the gasket.

2. The all-solid-state rechargeable battery manufacturing method as claimed in claim 1, wherein forming the finishing portion includes using a positive active material of the positive electrode.

3. The all-solid-state rechargeable battery manufacturing method as claimed in claim 1, wherein forming the finishing portion includes employing a solid electrolyte of the first solid electrolyte layer.

4. The all-solid-state rechargeable battery manufacturing method as claimed in claim 1, wherein forming the finishing portion includes using one of a powder application, a slurry spray coating and a slurry application.

5. The all-solid-state rechargeable battery manufacturing method as claimed in claim 1, wherein forming the finishing portion further comprises filling the gap with the finishing portion by pressing the positive electrode, the gasket, and the finishing portion.

6. The all-solid-state rechargeable battery manufacturing method as claimed in claim 1, further comprising:
forming a second laminate by stacking a second solid electrolyte layer on a second negative electrode; and
stacking the second solid electrolyte layer of the second laminate on the positive electrode, the finishing portion and the gasket.

7. The all-solid-state rechargeable battery manufacturing method as claimed in claim 6, further comprising pressing the second laminate to fill the gap with the finishing portion by pressing the positive electrode, the gasket, and the finishing portion.

8. An all-solid-state rechargeable secondary battery, comprising:
a negative electrode;
a solid electrolyte layer stacked on the negative electrode; and
a positive electrode layer including a positive electrode, a gasket, and a finishing portion between the positive electrode and the gasket, wherein no gap is present in the positive electrode layer.

9. The all-solid-state rechargeable secondary battery of claim 8, wherein the negative electrode and the solid electrolyte layer include a first laminate, the all-solid-state rechargeable secondary battery further comprising a second laminate stacked on the positive electrode layer.

10. The all-solid-state rechargeable secondary battery of claim 9, wherein the second laminate includes a second solid electrolyte layer stacked on the positive electrode layer and a second negative electrode stacked on the second solid electrolyte layer.

11. The all-solid-state rechargeable secondary battery of claim 8, wherein the negative electrode includes a precipitation-type negative electrode.

12. The all-solid-state rechargeable secondary battery of claim 11, wherein the negative electrode includes a current collector and a negative electrode coating layer on the current collector.

13. The all-solid-state rechargeable secondary battery of claim 11, wherein the negative electrode further includes a thin film between the current collector and a negative electrode coating layer.

14. The all-solid-state rechargeable secondary battery of claim 13, wherein the thin film includes a lithium alloy.

15. The all-solid-state rechargeable secondary battery of claim 8, wherein the positive electrode includes a current collector, a positive electrode active material and a conductive material.

16. The all-solid-state rechargeable secondary battery of claim 15, wherein the conductive material includes a carbon-based material and an oxide-based inorganic solid electrolyte.

17. The all-solid-state rechargeable secondary battery of claim 8, wherein the solid electrolyte layer includes a sulfide-based solid electrolyte.

18. The all-solid-state rechargeable secondary battery of claim 17, wherein the sulfide-based solid electrolyte includes argyrodite-type sulfide particles.
